(19) United States
(12) Patent Application Publication
(10) Pub. No.: US 2011/0183602 A1
(43) Pub. Date: Jul. 28, 2011

(54) JAMMING APPARATUS AND METHOD FOR JAMMING A TARGET SIGNAL

(75) Inventor: Marko Tietz, Wildau (DE)

(73) Assignee: INDUSTRIEANLAGEN-BETRIEBSGESELLSCHAFT MBH, Ottobrunn (DE)

(21) Appl. No.: 13/054,017

(22) PCT Filed: Jul. 13, 2009
(86) PCT No.: PCT/EP2009/005080

§ 371 Date: Apr. 7, 2011

(30) Foreign Application Priority Data
Jul. 14, 2008 (DE) 10 2008 033 001.9
Aug. 19, 2008 (DE) 10 2008 038 315.5

(51) Int. Cl. H04K 3/00

(52) U.S. Cl. 455/1

(57) ABSTRACT

In various areas of application, it is desirable to have a jamming apparatus for jamming radio signals which is greatly limited in geographical terms and ensures reliable jamming of the radio signals. The present application solves this problem by providing a jamming apparatus which comprises:
at least one detection device for detecting a target signal which is transmitted to at least one communication device;
at least one jamming device for jamming the target signal by means of a jamming signal;
a control device which is communicatively connected to the jamming device for the purpose of controlling it; wherein
the control device for controlling the at least one jamming device receives at least one input signal for determining a transmission power of the jamming device and/or a communication device.

Therefore, a central idea behind the present invention is to regulate the jamming signal in a dynamic manner. Efficient jamming of the device which transmits the target signal can thus be ensured.

The invention relates to a jamming apparatus and a method for jamming a target signal in accordance with the preamble of claims 1 and 12 respectively.

Corresponding jamming apparatuses are disclosed e.g. in US 2006/0153281 A1. They comprise a detection device for detecting a target signal which is exchanged between a transmitting device and a receiving device, and a jamming device which upon detection of a target signal to be jammed jams the target signal.

Jamming apparatuses are also known which continuously emit a jamming signal and thus prevent radio communication within a specific frequency band. For example, US 2007/0099559 A1 discloses a jamming apparatus for use in a theatre, cinema, hospital etc. The jamming transmitter continuously transmits and thus prevents communication by means of a mobile phone in a region specified by the local conditions. In order to interrupt the jamming signal and permit communication in the event of an emergency, the jamming apparatus of US 2007/0099559 A1 comprises a switch which can be activated e.g. in a remote-controlled manner and switches off the jamming signal. After the jamming transmitter has been switched off, a distress call can be transmitted and possible rescue operations can be coordinated over the mobile communications network.

In general, jamming transmitters for radio signals render it difficult or impossible to receive radio messages in a problem-free manner. In the same manner as the transmitter which is to be jammed, the jamming transmitter transmits energy in the form of electromagnetic waves and superimposes the original waves completely or partially. It can operate at the same frequency or adjacent frequency of the jammed receiver. The field strength, the modulation of the jamming signal and that of the jammed message are significant. It is also possible in the case of complex communication protocols to cause the communication to crash completely by transmitting false messages via a jamming transmitter.

US 2007/0297489 A1 describes an intelligent jamming transmitter which in accordance with a default permits communication on specific channels or (in the case of frequency-hopping) on a sequence of specific channels.

The above-described systems have the disadvantage that the jamming signal cannot be delimited to a sufficient extent spatially. Therefore, in densely populated areas it may be necessary to jam merely one demarcated area. For example, a cinema operator needs to prevent mobile telecommunication within a screening room. However, customers making telephone calls in the entrance hall of the cinema should not have their calls jammed by a corresponding jamming transmitter. Jamming mobile radio telecommunication outside the specified area can not only be annoying but can also contravene national laws.

Prisons or secured buildings are a further example of this. In this case, it can be necessary to prevent radio telecommunication within this building and in the adjoining outside areas. Since such buildings are also situated in a town, it is necessary to prevent jamming of adjoining areas or buildings. In order to be allowed to operate a corresponding jamming transmitter, it must be ensured that the jamming power of the transmitter beyond a specified boundary line does not exceed a specified value. Fluctuations must be taken into account by reason of the high density of buildings. It is occasionally not acceptable if the boundary line is exceeded by more than one meter. This is particularly problematic as the boundary conditions can change continuously depending on upon the type of communication. For example, vehicles, scaffolding, open and closed windows can influence the range of a jamming transmitter. The weather conditions, in particular rain, also have an effect upon the range of this transmitter. In the case of mobile communication systems, the transmission power of a base station is frequently varied. A jamming transmitter can reliably cover a larger or smaller area depending upon the adjusted transmission power.

On the basis of this prior art, the object of the present invention is to develop a jamming apparatus in such a manner that it permits efficient and reliable jamming of a target signal within geographically specified boundaries. A corresponding method for jamming a target signal is also to be provided.

In accordance with the invention, this object is achieved by a jamming apparatus in accordance with claim 1.

In particular, the object is achieved by a jamming apparatus, comprising:
at least one detection device for detecting a target signal which is transmitted to at least one communication device;
at least one jamming device for jamming the target signal by means of a jamming signal;
a control device which is communicatively connected to the jamming device for the purpose of controlling it; wherein
the control device for controlling the at least one jamming device receives at least one input signal for determining a transmission power of the jamming device and/or at least one communication device.

Therefore, a central idea behind the present invention is to adapt the control of the jamming device in a dynamic manner. In this case, the transmission power of the jamming device and/or a communication device (e.g. a base station) is taken into account. The target signal can be a signal which is sent from a transmitter to a receiver. Furthermore, the target signal can comprise a signal, which is transmitted by the transmitter, and a corresponding response by the receiver. For example, in the case of more complex communications protocols (e.g. GSM) it can be sufficient to jam signals of the receiver e.g. of the base station. However, any communication between the transmitter and receiver is preferably jammed.

In particular, the input signal for determining the transmission power of the jamming device should provide information as to how strongly a jamming signal transmitted by a jamming device is damped until it is detected. Therefore, changed environmental conditions (e.g. the weather, in particular rain), changes to a building (e.g. open or closed windows and doors) and obstacles (e.g. parked vehicles, scaffolding) can be detected and taken into account during control of the jamming device.

The control apparatus can comprise at least one sensor unit which for the purpose of generating the input signal receives the jamming signal of at least one jamming device and/or a signal of the at least one communication unit. It is feasible to control the transmission power of the at least one communication unit and accordingly to generate the input signal which provides information relating to this power. However, it is advantageous if the control apparatus comprises at least one sensor unit and measures signals of the jamming device and/or of the communication units. The control apparatus is thus independent of specified data and can take changes, be they inherent to the system or specified by the environment, into account more effectively.

The at least one sensor unit can comprise a directional antenna. This means that the sensor unit has an antenna having a strongly pronounced directional characteristic, whereby the geographical alignment of the sensor unit is defined. A corresponding antenna can be shielded in such a manner that exclusively or preferably signals, which are transmitted from a specific direction, are received. For example, directional antennas of this type can be installed on a wall such that they receive merely signals which are transmitted within the wall. Signals which are generated outside the wall are not taken into account in this case.

Therefore, it is possible, e.g. when measuring the transmission power of the at least one jamming device, to take merely signals which are generated within a specified geographical region into account. Corruption of the dynamic control of the jamming device by a “false” jamming transmitter which is located outside this specified geographical region is thus prevented. The directional antenna can thus be used for taking measurements in specific regions. A “selection” of jamming signals of specific or known jamming transmitters can also occur by virtue of the fact that the respective jamming signal of a jamming transmitter is communicated on a second path, in particular in wire-bound fashion, to the sensor unit as a synchronisation signal which then determines the jamming signal components which match the synchronisation signal.

The control device can be communicatively connected to the communication device in order to determine an activation time of the jamming signal. In order to achieve a more rapid reaction to the detection of a target signal, it can be advantageous to communicate the detection of the target signal directly to the jamming device. A suitable network is to be provided for this purpose. Alternatively, the detection can be communicated to the control device from where it is relayed to the jamming device.

The control device can comprise a processing device which processes the input signal and generates a jamming adjustment signal to adjust the transmission power of the at least one jamming device. This means that the transmission power of the at least one jamming device can be adapted to the measured transmission power of one or several communication devices or one or several jamming devices. In order to ensure efficient adjustment of the transmission power, the transmission power of the jamming device can be measured at a spatially remote position. Damping or super elevation of the jamming signal by means of the environment can thus be taken into account.

The at least one detection device can be communicatively connected to the jamming device. As already described, it is feasible to relay the detection of a target signal directly to the jamming device. In particular, a detection device and jamming device can be provided in one device. However, it is advantageous if notification of the control device takes place at least additionally.

Furthermore, communication from the control device to the detection device can be advantageous. Therefore, the control device can be designed for transmitting control signals to the at least one detection device, in order to adjust a received power of the detection device. It is thus possible to delimit not only the power of the transmitted jamming signals but also to adapt the sensitivity of the detection devices to the environment. In this way, it is possible to obviate “oversensitivity” of the detection devices. As long as a plurality of detection devices is provided, it is possible to detect the simultaneous transmission of several target signals, without any superpositioning occurring during detection. It is also feasible during detection of a target signal by a first detection device to increase the sensitivity of adjacent detection devices which do not receive the target signal or receive it only in a weak manner. If several detection devices receive the target signal, the position of the transmitter can be determined more precisely.

The jamming device can comprise a plurality of detection devices and a storage device for storing the position of the plurality of detection devices, in order to determine a transmission position of a device which generates the target signal. So long as the target signal is received by several detection devices and the position of the individual detection devices is known, it is possible to determine the transmission position e.g. by means of triangulation.

The jamming apparatus can comprise a plurality of jamming devices, wherein the aforementioned storage device is designed for storing the position of the plurality of jamming devices and the control device activates at least one jamming device in dependence upon the determined transmission position. This means that the control device can determine the position of the transmitting device with the aid of the plurality of detection devices and can activate one or several jamming devices accordingly. Therefore, jamming devices having a lower transmission power can be used, since the jamming devices which are installed in proximity to the device transmitting the target signal are activated in a selective manner.

The jamming apparatus can comprise monitoring devices, in particular cameras, wherein the control device is communicatively connected to the monitoring devices, in order to align and/or activate them in accordance with the determined transmission position. After a target signal has been detected and the position of the transmitting device has been determined, the control device can generate corresponding output signals, in order to use this information further. For example, corresponding cameras can be activated, in order to determine the position of the transmitter visually.

The control device can comprise at least one input and output device for interaction with at least one user. In particular, this can enable the user to activate or deactivate the jamming signal manually. For example, communication can be permitted in the event of an emergency. Furthermore, activation of the jamming signal can be confirmed manually by the user. Erroneous activation of the jamming signal can thus be prevented.

The object described above is also achieved by a method in accordance with the present claim 12. In particular, this object is achieved by a method for jamming a target signal which is transmitted to at least one communication device, wherein this method comprises the following steps:
detecting the target signal at least by means of a detection device;
transmitting a jamming signal for jamming the target signal by means of at least one jamming device;
determining a transmission power of the jamming device and/or a communication device;
adjusting the transmission power of the jamming device in dependence upon the determined transmission power.

Therefore, the jamming device is advantageously adjusted in accordance with the measured or specified transmission power of the jamming device and/or a communication device which is designed to receive the target signal.

The adjustment of the transmission power of the jamming device can include regulating the transmission power in accordance with a specified transmission power interval. In particular, a maximum power can be specified which must not be exceeded during transmission of the jamming signal. This specified transmission power can be position-dependent. Therefore, it is advantageous to determine the transmission power at specified locations or positions. These positions can be spatially remote from the jamming devices.

The transmission power interval can be adjusted in accordance with the determined transmission power of the communication device. This means that the maximum power of the jamming device can be dynamically adapted to the measured or determined transmission power of the communication device. It is thus possible to maintain a specified relationship between the power of the jamming signal and the power of the communication device. The adjusted power of the jamming device thus ensures reliable jamming of the target signal, wherein the influence of the environment is minimised.

Detection of the target signal can be effected by means of at least two detection devices and can be communicated to a control device, wherein the control device selects at least one jamming device from a plurality of jamming devices, in order to jam the target signal.

The method can comprise a determination of the position of the device which transmits the target signal, wherein a position of the at least one detection device which detects the target signal is determined.

Determination of the transmission power of the at least one jamming device and/or the at least one communication device can include measuring a transmission power by means of an antenna, in particular having a predetermined directional characteristic.

The method can comprise adjusting the received power of at least one detection device in dependence upon the determined transmission power.

After detection of the target signal, the jamming signal can be transmitted over a predetermined time interval. Jamming of the environment can also be limited with respect to time. Time-limiting is particularly advantageous if during communication between the transmitter and the receiver a protocol is used which requires the establishment of a connection. The connection can thus be interrupted by the jamming signal. As soon as an attempt is made to further establish a connection after transmission of the jamming signal, the connection can be interrupted once again. Although in this respect an exchange of protocol messages takes place, content cannot be exchanged via the communication connection.

The method can comprise a calibration, wherein at least one substantially “pure” carrier signal is transmitted by at least one jamming device, in order to determine the transmission power of the jamming device. This calibration can take place prior to a possible detection, in order to adjust the transmission power of the jamming device in a suitable manner. A carrier signal is particularly suitable for calibration, as it does not jam an allowed or permitted communication (e.g. outside a safety range) even when power is strong. In order to make the carrier signal more easily identifiable for calibration, it can also be modulated in a suitable manner so that it does not jam the radio signals (e.g. amplitude modulation).

The method can comprise processing of the target signal, in order to read out a transmitter identification number, in particular an IMSI (International Mobile Subscriber Identity) number. Furthermore, the transmitter identification number can be compared with a plurality of identification numbers in a positive list, wherein a jamming signal is not transmitted if the identification number of the transmitters is included in the positive list. It is thus rendered possible to allow specific devices to communicate.

The invention will be described hereinafter with reference to some embodiment examples which are explained in more detail by means of illustrations. In the drawings:

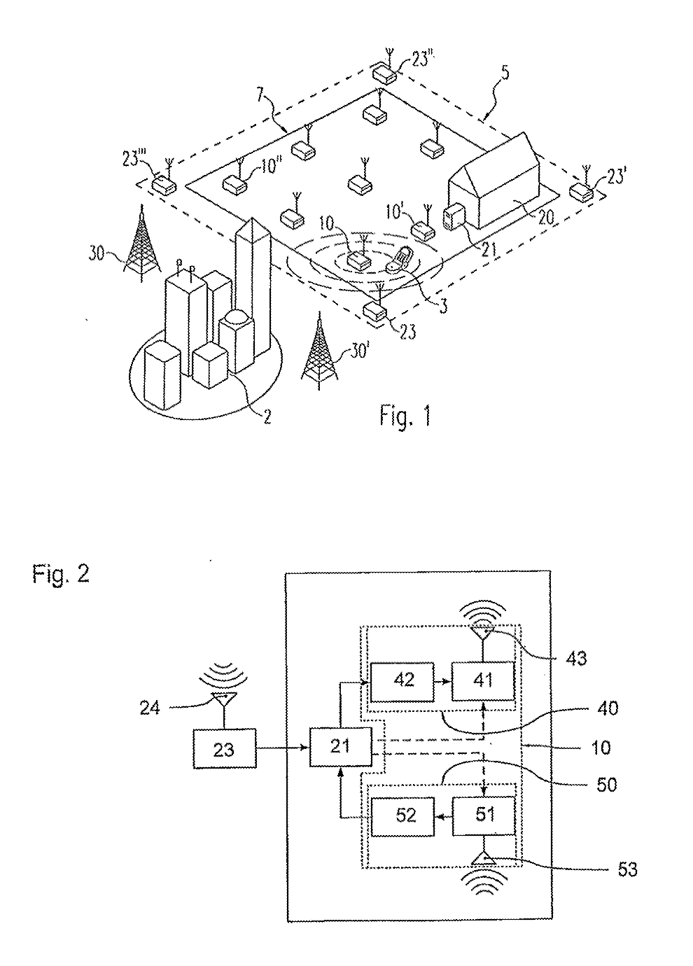

FIG. 1 shows the jamming apparatus in accordance with the invention having a plurality of transceiver units and sensor units;

FIG. 2 shows a block diagram of a transceiver unit having a central computer and sensor units; and

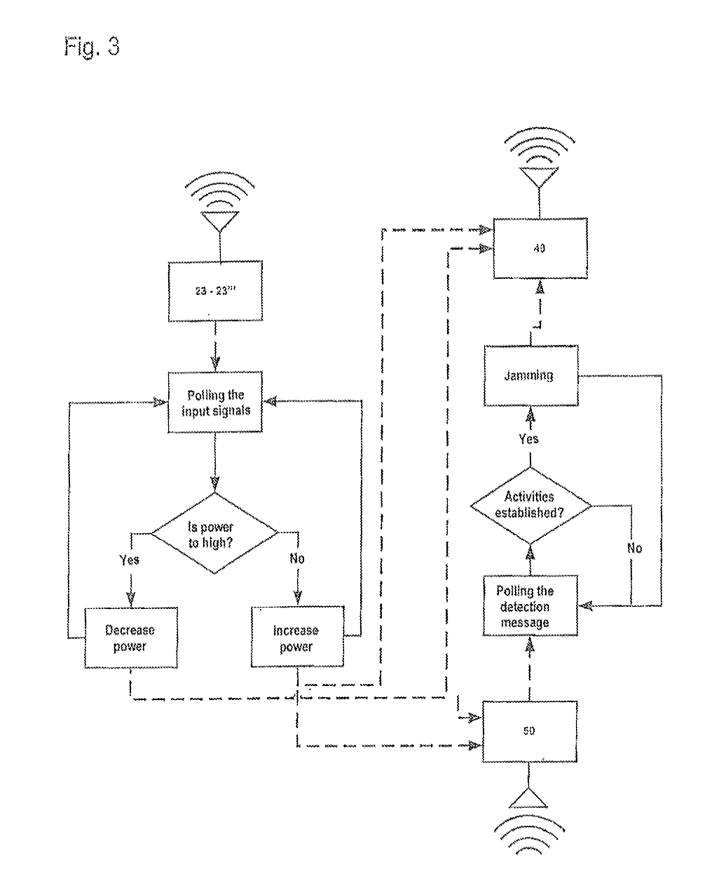

FIG. 3 shows a flowchart of a monitoring and regulating procedure in accordance with the invention.

The jamming apparatus in accordance with the invention is particularly suitable for use in densely populated areas. For example, the jamming apparatus in accordance with the invention can be used within a town.

FIG. 1 schematically illustrates a square jamming region 5 which is defined by a dashed line. Located within this jamming region 5 is a region which is defined by a wall 7 and which also has a square area. This wall 7 can symbolise e.g. the outer wall of a detention centre.

Located in proximity to the jamming region 5 are a town 2 and a first and second base station 30, 30′. In the present embodiment example, these base stations 30, 30′ permit mobile radio communication in accordance with the GSM or UTMS standard. Therefore, the owner of a mobile telephone is permitted to utilise services, such as telephony, line-switched or packet-switched data transfer, short messages etc. Communication via standards such as HSCSD, GPRS, HSPDA, EDGE and in future LTE can also be provided.

In a further embodiment example, the base stations 30, 30′ can span a wireless radio network or WLAN, and permit communication in accordance with the IEEE-802.11 standard.

However, the base stations 30, 30′ could also symbolise mobile hand-held transceivers which permit analogue radio communication.

In the embodiment example illustrated in FIG. 1, mobile radio communication is to be prevented within the wall 7 or between a mobile phone 3, which is located within the wall 7, and the base stations 30, 30′. Mobile telephones 3 which are located outside the jamming region 5 should not be adversely affected in terms of communication. For example, defaults can exist, according to which a jamming level outside the jamming region 5 must not exceed a specified limit value. In addition to or instead of this default, a default can exist which limits the ratio of transmission power of base station 30, 30′, which is received at a position, to jamming power of a jamming signal received at this location.

The present invention provides a solution for this, in that dynamic regulation of the jamming signal is effected. For this purpose, four sensor units 23 to 23′″ are positioned at the corner points of the jamming region 5. Located inside the jamming region 5 is a plurality of transceiver units 10, 10′, 10″ which are designed to detect a target signal of the mobile telephone 3 and transmit a corresponding jamming signal. The individual transceiver units 10, 10′, 10″ and the sensor units 23 to 23′″ are networked together. A central computer 21 at a control centre 20 communicates with the sensor units 23 to 23′″ and the transceiver units 10, 10′, 10″ via a corresponding network. The network can be a wire-bound or wireless network. The protocol used thereon can be real time-capable or not. In the present embodiment example, an Ethernet network is used.

A significant advantage of networking the devices resides in the fact that central alarming is possible in all occurrences. Furthermore, the activities of the monitoring devices, transceiver units 10-10″, sensor units 23-23′″ can be logged. A simple expansion of the network and a step by step installation of the hardware and a central control of all devices are feasible.

As illustrated in FIG. 2, a transceiver unit 10, 10′, 10″ comprises in each case a jammer unit 40 and a mobile telephone detection unit 50. The jammer unit 40 or jamming device comprises a signal generator 42, an amplifier 41 and an antenna 43. The signal generator 42 generates a jamming signal which is amplified by means of the amplifier 41 and is transmitted by means of the antenna 43.

The mobile telephone detection unit 50 comprises a detector 52, an amplifier 51 and an antenna 53. The antenna 53 is designed to receive a target signal which is transmitted by the mobile telephone 3. The amplifier 51 of the mobile radio detection unit 50 amplifies the received signal and relays it to the detector 52. As soon as the detector 52 establishes that the mobile telephone 3 is transmitting, i.e., a target signal is present, it outputs a corresponding detection message to the central computer 21. The central computer 21 reacts to this detection message, in that it sends an activation message to the jammer unit 40. On account of this message, the jammer unit 40 is activated and a corresponding jamming signal is sent. In order to minimise the transmission power of the jamming signal, the central computer 21 receives input signals from the sensor units 23 to 23′″ at regular intervals. In accordance with the received input signals, the central computer 21 specifies to the jammer unit 40 the power level at which it is to transmit. Furthermore, the central computer 21 can adjust the sensitivity of the mobile telephone detection unit 50 by means of corresponding signals.

FIG. 3 illustrates the sequences with the aid of two control loops.

In a first control loop, the central computer 21 polls the detection message of the mobile telephone detection unit 50. If no activities have been established by the mobile telephone detection unit, the detection message is polled once again. In this state, no jamming signal is transmitted. As soon as the activities have been established by the mobile telephone detection unit 50, jamming is effected by the transmission of a jamming signal by means of the jammer unit 40.

During a jamming procedure, the second control loop polls the input signals of the sensor units 23 to 23′″. If the received power of the jamming signal is too high at least one sensor unit 23 to 23′″, the power of the transmitting jammer unit 40 is reduced. The input signals are then polled once again. If the received power is too low (the target signal is not adequately jammed), the power is increased. This means that the central computer 21 transmits corresponding control signals to the jammer unit 40.

The control signals for the jammer unit 40 can also be transmitted to the mobile telephone detection unit 50, in order to adjust the sensitivity thereof.

It is feasible not only to regulate the received transmission power with the aid of a static limit value, but also to take measurements continuously—even if no jamming signal is transmitted—by means of the sensor units 23 to 23′″ which provide information relating to the transmission power of the base stations 30, 30′. In order to jam the target signal in a reliable manner, the limit value can be increased when the transmission power of the base stations 30, 30′ is high, whereas a jamming signal having a lower transmission power is sufficient when the power of the base stations 30, 30′ is low.

The present invention provides means for performing targeted jamming of a mobile telephone 3. Networking of the individual transceiver units 10, 10′, 10″ to the central computer 21 is used for this purpose. With regard to FIG. 1, a mobile telephone 3 which transmits a target signal is illustrated therein in proximity to a first transceiver unit 10. This transceiver unit 10 detects the target signal and transmits a corresponding message to the central computer 21. The central computer 21 transmits an activation message to the first transceiver unit 10 which transmits a corresponding jamming signal. The jamming signal can be received by the first sensor unit 23 and adjusted in such a manner that certain defaults in relation to the jamming level are not exceeded outside the jamming region 5.

It is feasible that the second transceiver unit 10′ likewise receives the target signal of the mobile telephone 3 and transmits corresponding messages to the central computer 21. The central computer can establish by reference to the received messages that the mobile telephone 3 is located between the first transceiver unit 10 and the second transceiver unit 10′. Accordingly, the respective jammer units 40 of the transceiver units 10, 10′ can be activated. A further transceiver unit 10″ does not receive the target signal and is also not activated by the central computer 21.

It is feasible that the central computer 21 knows the position of the first transceiver unit 10 and accordingly activates the second transceiver unit 10′, although it does not receive the target signal. Furthermore, the central computer 21 can know the position of the base station 30, 30′ and the transceiver unit 10 and can activate the transceiver units 10 to 10″ which are positioned between the position of the mobile phone 3 and the base stations 30, 30′. This ensures efficient jamming of the target signal, as the spatial positioning of the jammer units 40 is taken into account.

In the previously described embodiment example, a transceiver unit 10 to 10″ comprises in each case a jammer unit 40 and a mobile telephone detection unit 50. However, it is possible to dispose a plurality of jammer units 40 and mobile telephone detection units so as to be spatially separated from each other. As a result, the individual mobile telephone detection units 50 and jammer units 40 can be used more efficiently in accordance with their power characteristic. It is feasible to store the position of these individual mobile telephone detection units 50 and jammer units 40 in the central computer 21 and to control them intelligently. This means that the position of the mobile telephone 3 is determined in a first step and the jammer units 40 which can jam the localised mobile telephone 3 most effectively are selected in a second step. The sensor units 23 to 23′″ can likewise be used as mobile telephone detection units 50.

The sensor units 23 to 23′″ are preferably sensor units 23 to 23′″ which have antennas 24 with a strong directional characteristic. Therefore, only the target signals which are transmitted within the jamming region 5 are received. Any jamming of the power regulation of the jammer units 40 by means of a transmitter (e.g. by a “false” jammer unit 40) which is located outside the jamming region 5 in proximity to one of the sensor units 23 to 23′″ is thus precluded. This type of sensor unit 23 to 23′″ preferably comprises further antennas 24 which have a low directional characteristic and detect the signals of the base stations 30, 30′. Alternatively, a central sensor unit 23 to 23′″ can also be provided which serves exclusively to detect the signals of the base stations 30, 30′.

The central computer 21 is designed to activate the jammer units 40 in a time-limited manner. Deactivation can also be effected after a specified time interval, e.g. ≦1 min or 30 s. It is also feasible to use the mobile telephone detection unit 50 to detect an interruption in the transmission of the target signal and to deactivate the jammer units 40 accordingly.

It is also possible to connect the central computer 21 to an IMSI catcher or to the base stations 30, 30′. Therefore, when a communication connection is established with one of the base stations 30, 30′, it would be possible to determine the IMSI number of the mobile telephone 3 and to take it into account during activation of the jammer units 40. For example, there can be a positive list of IMSI numbers. The mobile telephones 3 which have an IMSI number included on this positive list are not jammed by the jamming apparatus in accordance with the invention. Therefore, rescue teams or supervisory staff can communicate using their mobile telephones 3.

### LIST OF REFERENCE NUMERALS

2 town
3 mobile telephone
5 jamming region
7 wall
10, 10′, 10″ transceiver unit
20 control centre
21 central computer
23 to 23′″ sensor unit
24 antenna of the sensor unit
30, 30′ base station
40 jammer unit
41 amplifier
42 signal generator
43 antenna of the jammer unit
50 mobile telephone detection unit
51 amplifier
52 detector
53 antenna of the detection unit

1. Jamming apparatus for jamming a radio signal, comprising:
at least one detection device (50) for detecting a target signal which is transmitted to at least one communication device (30, 30′);
at least one jamming device (40) for jamming the target signal by means of a jamming signal;
a control device (21) which is communicatively connected to the jamming device (40) for the purpose of controlling it;
wherein the control device (21) for controlling the at least one jamming device (40) receives at least one input signal for determining a transmission power of the jamming device (40).

2. Jamming apparatus according to claim 1, characterised by at least one sensor unit (23) which for the purpose of generating the input signal receives the jamming signal of the at least one jamming device (40).

3. Jamming apparatus according to claim 1, wherein the at least one sensor unit (23) comprises a directional antenna (24).

4. Jamming apparatus according to claim 1, wherein the jamming apparatus (40) is communicatively connected to the detection device (50) in order to determine an activation time of the jamming signal.

5. Jamming apparatus according to claim 1, wherein the control device (21) comprises a processing device which processes the input signal and generates a jamming adjustment signal for adjusting a transmission power of the at least one jamming device (40).

6. Jamming apparatus according to claim 1, wherein the at least one detection device (50) is communicatively connected to the control device (21).

7. Jamming apparatus according to claim 6, wherein the control device (21) is designed for transmitting control signals to the at least one detection device (50), in order to adjust a received power of the detection device (50).

8. Jamming apparatus according to claim 1, characterised by a plurality of detection devices (50) and a storage device for storing the position of the plurality of detection devices (50), in order to determine a transmission position of a device which generates the target signal.

9. Jamming apparatus according to claim 8, characterised by a plurality of jamming devices (40), wherein the storage device is designed for storing the position of the plurality of jamming devices (40), and the control device (21) activates at least one jamming device (40) in dependence upon the determined transmission position.

10. Jamming apparatus according to claim 8, characterised by monitoring devices, in particular cameras, wherein the control device (21) is communicatively connected to the monitoring devices, in order to align and/or activate them in accordance with the determined transmission position.

11. Jamming apparatus according to claim 1, wherein the control device (21) comprises at least one input and output device for interacting with at least one user, in particular for manual activation of the jamming signal.

12. Method for jamming a target signal which is transmitted to at least one communication device (30, 30′), comprising the steps of:
detecting the target signal by means of at least one detection device (50);
transmitting a jamming signal for jamming the target signal by means of at least one jamming device (40);
characterised by
determining a transmission power of the jamming device (40);
adjusting the transmission power of the jamming device (40) in dependence upon the determined transmission power.

13. Method according to claim 12, wherein the adjustment of the transmission power of the jamming device (40) includes regulating the transmission power in accordance with a specified transmission power interval.

14. Method according to claim 13, wherein the transmission power interval is adjusted in accordance with the determined transmission power of the communication device (30, 30′).

15. Method according to claim 12, characterised by a determination of the position of a device (3) which transmits the target signal, wherein a position of the at least one detection device (50) is used in order to determine the position of the device (3).

16. Method according to claim 15, wherein in accordance with the determination of the position of the device (3) the control device (21) selects at least one jamming device (40) from a plurality of jamming devices (40) for jamming the target signal.

17. Method according to claim 12, wherein the determination of the transmission power of the at least one jamming device (40) and/or the at least one communication device (30, 30′) comprises measuring a transmission power by means of an antenna (24), in particular having a predetermined directional characteristic.

18. Method according to claim 12, characterised by an adjustment of the received power of at least one detection device (50) in dependence upon the determined transmission power.

19. Method according to claim 12, wherein after the target signal has been detected the jamming signal is transmitted over a predetermined time interval.

20. Method according to claim 12, characterised by a calibration, wherein at least one carrier signal is transmitted by at least one jamming device (40), in order to determine the transmission power of the jamming device (40).

21. Method according to claim 12, characterised by a processing of the target signal, in order to read out a transmitter identification number, in particular an IMSI number;
comparing the transmitter identification number with a plurality of identification numbers in a positive list,
wherein a jamming signal is not transmitted if the transmitter identification number is included in the positive list.
